(19) United States
(12) Patent Application Publication
(10) Pub. No.: US 2008/0156975 A1
(43) Pub. Date: Jul. 3, 2008

(54) MULTI-EVALUATION CORE LOGGER

(76) Inventor: John A. Kieschnick, Edmond, OK (US)

Correspondence Address: SCHLUMBERGER INFORMATION SOLUTIONS, 5599 SAN FELIPE, SUITE 1700, HOUSTON, TX, 77056-2722, US

(21) Appl. No.: 11/669,906

(22) Filed: Jan. 31, 2007

Related U.S. Application Data
(60) Provisional application No. 60/882,843, filed on Dec. 29, 2006.

(51) Int. Cl. G01V 5/00

(52) U.S. Cl. 250/255

(57) ABSTRACT

Method, system, and apparatus are disclosed for conducting multiple types of evaluations on a core sample. The multiple types of evaluations allow core samples from historically problematic formation materials, such as those having consistently high gamma responses, to be reliably positioned downhole. Disparate types of evaluations may be obtained in a single pass of the core sample, thereby reducing the number of test environments imposed on the core sample. Where more than one pass is desired, different evaluations may be performed without changing out detectors and measurement devices. Evaluations that are normally acquired in a wellbore using a wireline tool, as well as those that cannot be easily conducted downhole for various reasons, may instead be performed on the core sample. Such an arrangement provides a more robust and flexible way of analyzing core samples than existing techniques.

### CROSS-REFERENCE TO RELATED APPLICATIONS

This application for patent claims priority to, and hereby incorporates by reference, U.S. Provisional Application Ser. No. 60/882,843, entitled “Multi-Evaluation Core Logger,” filed Dec. 29, 2006, with the United States Patent and Trademark Office.

### BACKGROUND OF THE INVENTION

1. Field of the Invention

The present invention relates to techniques for evaluating a subterranean formation. More particularly, the invention relates to methods, apparatuses, and systems for testing and analyzing samples removed from such subterranean formations.

2. Background of the Related Art

Wellbores are drilled in a subterranean formation to locate and recover hydrocarbons, such as oil, gas, and the like. Typically, a downhole drilling tool with a drill bit at an end thereof is advanced into the formation to form a wellbore. As the drilling tool is advanced, a drilling mud is pumped from a surface mud pit through the drilling tool and out the drill bit to cool the drilling tool and also to carry away formation cuttings. The drilling mud exits the drill bit and flows back up to the surface for recirculation through the drilling tool.

To facilitate locating and recovering of the hydrocarbons, various evaluations are performed on the formation penetrated by the drilling tool. From these evaluations, important information about the properties and characteristics of the formation may be derived. This information may then be used by appropriate personnel to make drilling and production decisions. To this end, the drilling tool may be provided with devices for evaluating the surrounding formation. Alternatively, the drilling tool itself may be used to evaluate the surrounding formation. In still other cases, the drilling tool may be removed and a wireline tool may be deployed down the wellbore to evaluate the surrounding formation.

FIG. 1 is a schematic view, partially in cross-section, of a wireline operation 100 in which a wireline tool or sonde 104 is used to evaluate the subterranean formation. Typically, the wireline tool 104 is lowered down an open wellbore from a rig 102 to a depth corresponding to a desired interval in the formation 106. The wireline tool 104 is then drawn up the wellbore while measurements of formation properties are acquired using various sensors and detectors mounted on the wireline tool 104. The acquired measurements are transmitted from the wireline tool 104 via a wired or wireless connection to recording devices in a surface data acquisition unit 108 where they are recorded in a well log. These measurements may include, for example, electrical properties (e.g., resistivity and conductivity at specific frequencies, etc.), gamma radiation, active and passive nuclear measurements, sonic properties, dimensional measurements of the wellbore, formation pressure measurements, and the like.

When specific characterization of the formation 106 is required, samples of formation material may be taken from one or more formation intervals and brought to the surface, usually in the form of a cylindrical core. A typical coring operation 110 is shown in FIG. 1 near the wireline operation 100. The coring operation 110 involves attaching a core bit 114 to the end of a drillstring and lowering the core bit 114 into the formation 106 from a rig 112 to the interval of interest. The core bit 114 resembles a typical drag bit, but with a hole in its center that opens into a core barrel and core catcher. The hole allows the core bit 114 to cut a cylindrical section of formation material that is subsequently taken into the core barrel and secured by the core catcher. The cylindrical section or core of formation material may then be removed to the surface for evaluation.

Evaluation of the core sample is typically performed using a core gamma logger, an example of which is illustrated in FIG. 2 at 200. Existing core gamma loggers like the one in FIG. 2 operate primarily to generate one of two types of gamma responses: a spectral gamma signature, or a total gamma response. The spectral gamma signature separates the level of potassium, uranium, and thorium responses from the core sample and, when combined correctly, yields a total gamma response as well, whereas the total gamma response simply indicates the total gamma radiation naturally emitted from the core sample. These gamma values are recorded in a core gamma log 202 over the length of the core sample and subsequently used to derive various information about the formation, including the clay type, clay volume, and the like. The core gamma log 202 may also be correlated to a well log 204 of the formation to determine the depth from which the core sample was taken.

As can be seen in FIG. 2, the main components of the core gamma logger 200 include a computerized display 206, a housing or carriage 208, and a conveyor belt 210. These components are well known to those having ordinary skill in the art and will only be described briefly here. The computerized display 206 is usually a standard monitor (e.g., CRT, LCD, etc.) that can display various types of graphical and textual information for the core gamma logger 200. The carriage 208 houses a standard gamma radiation measurement device 212, typically a sodium iodide scintillation detector 214, that detects the gamma radiation from a core sample 216. The conveyer belt 210 carries the core sample 216 across the detection area of the measurement device 212 at a predetermined user-selectable speed. An isolation tunnel 218 helps shield the core sample 216 from any background radiation that may adversely affect the accuracy of the measurement device 212. Finally, although not expressly shown, a computerized data acquisition system is usually present for receiving and recording the measurements from the measurement device 212.

To operate, the core sample 216 is loaded onto the conveyor belt 210 and passed through the isolation tunnel 218 over the detection area of the measurement device 212. The measurement device 212 measures gamma radiation from the core sample 216 and outputs these measurements to the computerized data acquisition system. The computerized data acquisition system receives the measurements and records them in a core gamma log 202. If conformation is desired, additional passes of the core sample 216 through the isolation tunnel 218 may be conducted and repeat measurements recorded in an additional core gamma log 202. The measurements in the core gamma log 202 are typically recorded on the same vertical or depth scale as those in the well log 204 so that the two logs may be overlain for correlation purposes. The two logs 202 and 204 may then be correlated to determine or confirm the location of the core sample 216 within the formation 106.

While use of a core gamma log 202 to determine the location of a core sample 216 within a formation 106 is a generally accepted technique in the hydrocarbon industry, certain types of formations, such as heterogeneous shale reservoirs, have consistently high gamma responses that are not easily correlated to a well log 204. For this reason, as well as to further characterize the core sample 216, other types of evaluations are often needed. But because the core sample 216 can crumble easily once removed from its pressurized surroundings within the formation 106, subjecting it to multiple evaluations in disparate test environments may destroy the core sample 216. Compounding the problem, harsh environmental conditions inside most wellbores make it difficult to reliably perform some of these evaluations in-situ using a wireline tool 102. And wireline tools 102 cannot usually be deployed in formation intervals where the wellbore is drilled substantially horizontally.

Thus, despite recent advances in subterranean formation evaluation techniques, there remains a need for more robust and flexible methods, systems, and apparatuses for analyzing core samples. In addition, it is desirable that such methods, systems, and apparatuses be able to provide, among other things, one or more of the following: evaluations that can be used for correlating core samples having consistently high gamma responses, multiple types of evaluations in a single pass of a core sample, evaluations that sometimes cannot be acquired using a wireline tool, and evaluations from a core sample that are traditionally acquired from a wireline tool.

### SUMMARY OF THE INVENTION

The present invention is directed to methods, systems, and apparatuses for conducting multiple types of evaluations on a core sample. The multiple types of evaluations allow core samples from historically problematic formation materials, such as those having consistently high gamma responses, to be reliably correlated. Disparate types of evaluations may be obtained in a single pass of the core sample, thereby reducing the number of test environments imposed on the core sample. Where more than one pass is desired, different evaluations may be performed without changing out detectors and measurement devices. Evaluations that are normally acquired in a wellbore using a wireline tool, as well as those that cannot be easily conducted downhole for various reasons, may instead be performed on the core sample. Such an arrangement provides a more robust and flexible way of analyzing core samples than existing techniques.

In at least one aspect, the invention relates to a multi-evaluation subterranean core sample analysis apparatus. The apparatus comprises an isolation tunnel having an interior area substantially shielded from background radiation and a conveyor belt configured to convey a core sample through the interior area of the isolation tunnel, the core sample being extracted from a subterranean formation. The apparatus also comprises a multi-detector carriage assembly positioned adjacent to the conveyor belt and configured to house multiple types of detectors at a time, each type of detector configured to conduct a different type of evaluation on the core sample.

In another aspect, the invention relates to a multi-evaluation subterranean core sample analysis system. The system comprises a plurality of detectors, each detector designed to conduct a different type of evaluation on a core sample, the core sample being extracted from a subterranean formation. The system also comprises a data acquisition unit connected to the plurality of detectors, the data acquisition unit configured to acquire readings from the plurality of detectors substantially in parallel. The system further comprises a display connected to the data acquisition unit, the display configured to display the readings acquired by the data acquisition unit.

In yet another aspect, the invention relates to a multi-evaluation subterranean core sample analysis method. The method comprises extracting a core sample from a subterranean formation, preparing the core sample for analysis, conducting a first evaluation on the core sample, and conducting a second evaluation on the core sample substantially simultaneously with the first evaluation, wherein the first evaluation and the second evaluation being of different evaluation types.

### BRIEF DESCRIPTION OF THE DRAWINGS

So that the above recited features and advantages of the invention can be understood in detail, a more particular description of the invention, briefly summarized above, may be had by reference to the embodiments thereof that are illustrated in the appended drawings. It is to be noted, however, that the appended drawings illustrate only typical embodiments of this invention and are therefore not to be considered limiting of its scope, for the invention may admit to other equally effective embodiments. Moreover, the appended drawings are not drawn to any particular scale and are not intended to be used as blue prints or manufacturing drawings.

FIG. 1, described previously, illustrates an example of a standard wireline operation and a standard coring operation;

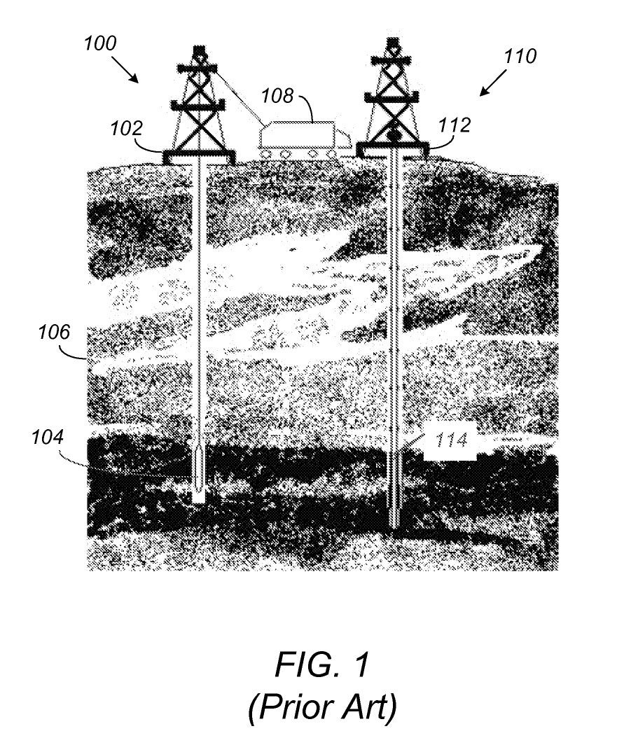

FIG. 2, described previously, illustrates an example of a core analysis system for providing a single type of core sample evaluation according to the prior art;

FIG. 3 illustrates an example of a core analysis apparatus for providing multiple types of core sample evaluations according to preferred embodiments of the invention;

FIG. 4 illustrates an example of a core analysis system for providing multiple types of core sample evaluations according to preferred embodiments of the invention;

FIG. 5 illustrates an example of a core analysis method for providing multiple types of core sample evaluations according to preferred embodiments of the invention; and

FIG. 6 illustrates an example of a core log having multiple types of evaluations according to preferred embodiments of the invention.

### DETAILED DESCRIPTION OF THE DRAWINGS

In the following detailed description of a preferred embodiment and other embodiments of the invention, reference is made to the accompanying drawings. It is to be understood that those of skill in the art will readily see that other embodiments and changes may be made without departing from the scope of the invention. Moreover, the accompanying drawings are not drawn to any particular scale and are not intended to be used as blue prints or manufacturing drawings of any kind.

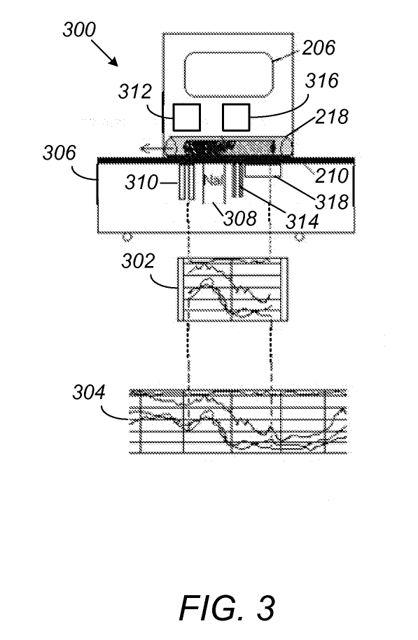

Referring now to FIG. 3, a multi-evaluation core analysis apparatus 300 for providing multiple types of core sample evaluations is shown. Measurements obtained from these core sample evaluations may then be recorded in a multi-response core log 302 and subsequently compared and/or correlated to their corresponding measurements in a downhole log 304 (e.g., a wireline log). Such a multi-evaluation core analysis apparatus 300 provides a more robust and flexible way of analyzing core samples than existing core analysis systems. In particular, the multiple types of evaluations allow core samples from historically problematic formation materials, such as those having consistently high gamma responses, to be reliably correlated. Furthermore, disparate types of evaluations may be obtained using the same multi-evaluation core analysis apparatus 300, often in a single pass (i.e., substantially simultaneously), thereby reducing the number of test environments imposed on the core sample. Where different evaluations are performed using different passes of the core sample, such evaluations may be performed without swapping out detectors and measurement devices. Moreover, evaluations that are normally acquired in a wellbore (e.g., using a wireline tool), as well as those that cannot be easily conducted downhole for various reasons, may now be performed using the multi-evaluation core analysis apparatus 300.

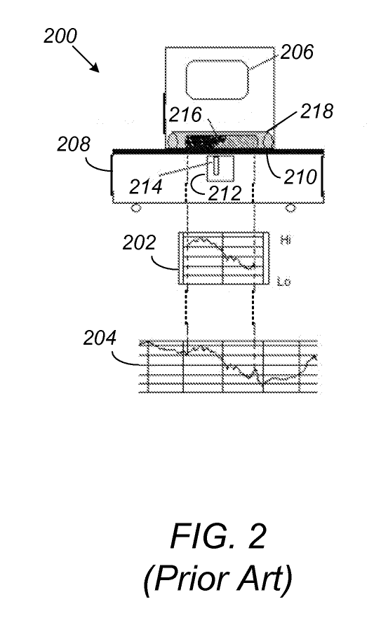

As can be seen in FIG. 3, the multi-evaluation core analysis apparatus 300, like the core gamma logger 200 in FIG. 2, comprises a computerized display 206, a conveyor belt 210, and an isolation tunnel 218. The display 206 displays various graphical and textual information for the evaluations and the conveyor belt 210 conveys the core sample 216 through the isolation tunnel 218. However, unlike the gamma logger 200 in FIG. 2, the multi-evaluation core analysis apparatus 300 further comprises a multi-detector carriage assembly 306 for housing multiple types of detectors and measurement devices. Such a multi-detector carriage assembly 306 includes, among other things, support structures (not expressly shown) known to those having ordinary skill in the art for securely retaining and fixedly holding multiple types of detectors and measurement devices therein. One or more detectors and measurement devices may then be mounted in the carriage assembly 306 to measure different responses of the core sample 216. This arrangement allows multiple and disparate types of core sample evaluations to be conducted using the same multi-evaluation core analysis apparatus 300, often in a single pass of the core sample 216 through the isolation tunnel 218.

One of the detectors or measurement devices that may be housed in the multi-detector carriage assembly 306 of the multi-evaluation core analysis apparatus 300 may be a gamma radiation measurement device 308. The gamma radiation measurement device 308 may be any gamma radiation measurement device known to those having ordinary skill in the art, but is preferably a sodium iodide scintillation detector that is capable of detecting, for example, spectral gamma and total gamma radiation as well as photoelectric absorption cross-section index and the like from the core sample 216. To increase its efficiency, the sodium iodide scintillation detector 308 may be turned so that it is perpendicular to the core sample 216, thereby increasing the detector's sensitivity to the exposed core sample 216. It has been found in some cases that turning the sodium iodide scintillation detector 308 perpendicular to the core sample 216 increases the capture efficiency of the detector to about 94 percent compared to only about 84 percent in existing solutions.

Another detector or measurement device that may be housed in the multi-detector carriage assembly 306 of the multi-evaluation core analysis apparatus 300 may be a compensated density detector 310. The compensated density detector 310 may be any suitable compensated density detector known to those having ordinary skill in the art, but is preferably a pair of sodium iodide detectors or other gamma detectors spaced apart by a predefined distance from each other and a predetermined distance from a gamma source 312, such as Cesium 137. In one implementation, the spacing between the sodium iodide detectors may be about one inch, and the distance from the sodium iodide detectors and the gamma source 312 may be a fixed distance, such as five inches, to accommodate cores four inches in diameter or less. The gamma source 312 may be any suitable gamma source known to those having ordinary skill in the art, including Cesium 137, and may be securely mounted above the core sample 216 directly across from the compensated density detector 310 assembly in any manner (e.g., brackets) known to those having ordinary skill in the art.

Yet another detector or measurement device that may be housed in the multi-detector carriage assembly 306 of the multi-evaluation core analysis apparatus 300 may be a compensated neutron detector 314. The compensated neutron detector 314 may be any suitable compensated neutron detector known to those having ordinary skill in the art, but is preferably a pair of lithium glass scintillation detectors or other neutron detectors spaced apart by a predefined distance from each other and a predetermined distance from a neutron source 316. In one implementation, the spacing between the lithium glass scintillation detectors may be about one inch, and the distance from the sodium iodide scintillation detectors and the neutron source 316 may be fixed as with the compensated density device described earlier. The neutron source 316 may be any suitable neutron source known to those having ordinary skill in the art, and may be securely mounted above the core sample 216 directly across from the compensated neutron detector 314 in any manner (e.g., brackets) known to those having ordinary skill in the art.

Other detectors and measurement devices, generally indicated here at 318, may also be added to or removed from the multi-detector carriage assembly 306 of the multi-evaluation core analysis apparatus 300 depending on the particular needs of the application. In general, any evaluation that may be performed downhole on the formation, as well as evaluations that cannot be easily performed downhole, may be duplicated or otherwise reproduced using the multi-evaluation core analysis apparatus 300.

Specific examples of evaluations that may be performed using the multi-evaluation core analysis apparatus 300 include nuclear, electromagnetic, sonic, compensated density, compensated neutron, photoelectric absorption cross-section index, and the like. Additional evaluations may include near-infrared, resistivity, elemental capture spectroscopy, X-ray diffraction, light absorption spectra, Fourier transform infrared spectroscopy, and the like. These evaluations are well known to those having ordinary skill in the art and will therefore be described only briefly here.

In general, a nuclear evaluation may involve any one of a suite of logs derived from nuclear reactions taking place either in the formation or the logging tool that provide important information about rocks and fluids in the formation. Nuclear logs are usually downhole logs obtained using a downhole logging tool, such as a wireline tool, equipped with a radiation detector and a radiation source.

An electromagnetic evaluation typically involves a downhole log obtained by applying an electromagnetic field, including application of a direct current where conductivity and/or resistivity are being measured as well as the use of the formation's natural electromagnetic fields. Electromagnetic responses are primarily used to measure the amount of hydrocarbons in the pores of the formation.

A sonic evaluation typically refers to a type of log that measure travel time of compression waves (P-waves) or shear waves (S-waves) versus depth. Sonic responses are typically recorded by pulling a logging tool on a wireline up the wellbore. The logging tool emits a sound wave from an acoustic source in the tool that travels from the logging tool to the formation and back to a receiver in the tool.

A compensated density evaluation typically refers to a density log that has been corrected for the effects of the wellbore environment (e.g., mud and mudcake) by using two or more gamma radiation detectors at different distances or spacing from a gamma radiation source. In a typical two-detector compensation scheme, the density measured by the far detector is corrected by an amount that is a function of the difference between the densities measured by the far detector the near detector. The correction is found to depend on the difference between formation and mudcake density multiplied by mudcake thickness. In the case of core measurements, the correction would be to overcome the diametric changes of the core. The process of coring itself often produces a core with changing diameters (i.e., cork screwing), while sometimes coring fluid sensitivity can also alter the core's diameter (i.e., clay expansion).

A compensated neutron evaluation, like the compensated density evaluation, typically refers to a neutron log in which the effects of the wellbore environment (e.g., mud and mudcake) are minimized by using two detectors. In the most common technique, the source-to-detector spacing of the two detectors is chosen so that the ratio of the count rates of the two detectors is relatively independent of the borehole environment or for core diametric changes. This ratio may be calibrated using a known formation and borehole environment. Correction factors may then be developed to convert the measured log to the standard conditions.

A photoelectric absorption cross-section evaluation typically refers to a downhole log that measures the photoelectric absorption factor, Pe. This factor is proportional to the atomic number of the formation and therefore may be used to determine the lithology of the formation. For example, it has been found that sandstone has a low Pe while dolomite and limestone have a high Pe. Clays, heavy minerals, and iron-bearing minerals also have a high Pe. The log is often recorded as part of a density measurement.

A near-infrared (NIR) evaluation typically refers to a downhole log obtained using the near infrared region of the electromagnetic spectrum (i.e., from about 800 nm to 2500 nm). The log is often used to provide spectroscopic imaging of the formation surrounding the wellbore.

An elemental capture spectroscopy (ECS) evaluation typically refers to a log of the yields of different elements in the formation, as measured by capture gamma spectroscopy using a pulsed neutron generator. The log is a type of pulsed neutron spectroscopy log that uses only the capture spectrum. The capture spectrum is formed by many elements, but because the main purpose of the log is to determine lithology, the principal outputs are the relative yields (i.e., concentration) of silicon, calcium, iron, sulfur, titanium and gadolinium.

X-ray diffraction evaluation typically refers to a technique of measuring diffraction peaks in X-rays diffracted by a rock sample to provide a semi-quantitative mineralogical analysis of the rock sample. The position of the diffraction peaks provides a measure of the distance between discrete crystallographic diffracting planes within minerals, while their intensity indicates the quantity of the mineral. The technique is considered only semi-quantitative because the size and shape of the diffraction peaks are strongly influenced by the geometry of the measurement, for example, the orientation of the minerals, and sample preparation.

Light absorption spectroscopy is an analytical tool used by chemists and physicists to determine the concentration of a particular compound and also to study the structure of a substance. It is based on the absorption of light by a chemical substance and subsequent promotion of electrons from one energy level to another in that substance. The wavelength at which the incident photon is absorbed is determined by the difference in the available energy levels. Typically, X-rays are used to reveal chemical composition and near ultraviolet to near infrared wavelengths are used to distinguish the configurations of various isomers in detail.

A Fourier transform infrared (FTIR) spectroscopy or evaluation typically refers to a technique for quantitative mineralogical analysis of a rock sample by measuring the effect of midrange infrared radiation transmitted through the sample. The radiation excites vibrations in the chemical bonds within the mineral molecules at particular frequencies characteristic of each bond. The transmitted radiation is compared with the spectral standards for a wide variety of minerals to determine the quantity of each mineral in the sample.

Although a few specific examples of evaluations have been described above, those having ordinary skill in the art will understand that the invention is not limited thereto and that other evaluations may also be performed without departing from the scope of the invention.

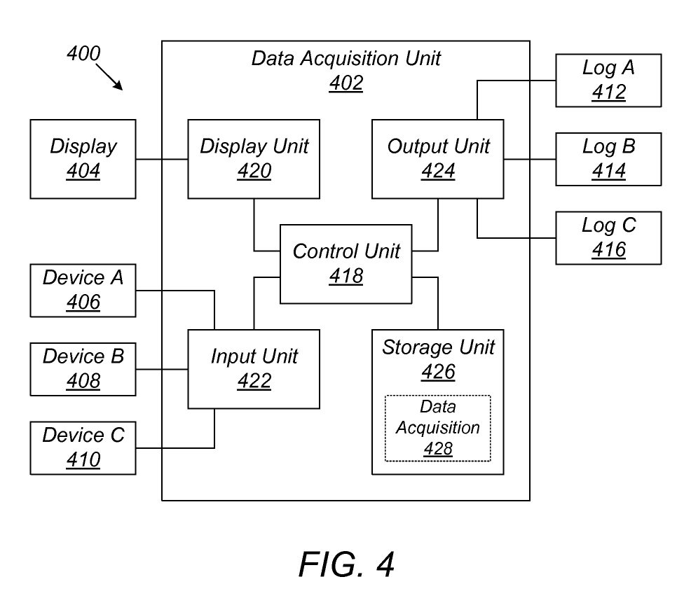

FIG. 4 illustrates in block diagram form an exemplary multi-evaluation core analysis system 400 for substantially simultaneously providing multiple types of core sample evaluations in a manner similar to the multi-evaluation core analysis apparatus 300 of FIG. 3. In this regard, the multi-evaluation core analysis system 400 is useful for evaluating core samples from otherwise problematic formation materials, like those having consistently high gamma responses. In addition, disparate types of evaluations may be obtained using the same multi-evaluation core analysis system 400, thereby reducing the number of test environments imposed on the core sample. Moreover, evaluations that are normally acquired in a wellbore with a wireline tool, as well as those that cannot be easily conducted downhole for some reason, may instead be performed using the multi-evaluation core analysis system 400.

As can be seen in FIG. 4, the core analysis system 400 has a number of functional components, including a data acquisition unit 402, a display 404, and a plurality of detectors and measurement devices identified here as 406 (Device A), 408 (Device B), and 410 (Device C), connected to the data acquisition unit 402. The multiple detectors and measurement devices 406-410 may be any suitable detectors and measurement devices known to those having ordinary skill in the art, including analog and/or digital detectors and measurement devices. In one implementation, the detectors and measurement devices 406-410 may be one or more of the detectors and measurement devices discussed with respect to FIG. 3 for obtaining spectral gamma, total gamma, nuclear, electromagnetic, sonic, compensated density, compensated neutron, photoelectric absorption index, near-infrared, resistivity, elemental capture spectroscopy, X-ray diffraction, light absorption spectra, and Fourier transform infrared spectroscopy responses, and the like. Such an arrangement allows multiple types of core sample evaluations to be conducted using the same multi-evaluation core analysis system 400, often in a single pass of the core sample. Should different evaluations using different passes of the core sample be desired, the evaluations may be performed without swapping out any detectors or measurement devices 406-410.

For all evaluations, the various measurements and readings from the analog and/or digital detectors and measurement devices 406-410 may be acquired and processed by the data acquisition unit 402. The data acquisition unit 402 also functions to record these measurements and readings in one or more logs, shown in FIG. 4 at 412 (Log A), 414 (Log B), and 416 (Log C). These measurements and readings may additionally be displayed on the display 404, which may be any suitable display (e.g., CRT, LCD, plasma, etc.) known to those having ordinary skill in the art. The display 404 may further display, for example, a graphical user interface for allowing a user to operate the core analysis system 400, including selectively starting and stopping the detectors and measurement devices 406-410 in parallel and one at a time as well as customizing the output format of the logs 412-416.

The data acquisition unit 402, like the detectors and measurement devices 406-410, may be any suitable data acquisition unit known to those having ordinary skill in the art. Preferably, the data acquisition unit 402 is capable of substantially simultaneously acquiring and processing multiple streams of analog and digital data from multiple sources. In one implementation, the data acquisition unit 402 may include a control unit 418, a display unit 420, an input unit 422, an output unit 424, and a storage unit 426. Briefly, the control unit 418 controls the operation of the various components of the data acquisition unit 402 and may be a general-purpose or application-specific microcontroller or microprocessor. The display unit 420 controls the display 404 and may be any suitable video controller known to those having ordinary skill in the art. The input unit 422 receives the analog and/or digital measurements and readings from the detectors and measurement devices 406-410 and may be any suitable input device known to those having ordinary skill in the art that is capable of handling parallel streams of data. The output unit 424 outputs the various measurements and readings from the detectors and measurement devices 406-410 to the logs 412-416 and may be any suitable output device known to those having ordinary skill in the art that is capable of outputting parallel streams of data. Finally, the storage unit 426 stores any software programs (e.g., operating system, spreadsheet program, etc.) as well as any data needed by the data acquisition unit 402, including the measurements and readings from the detectors and measurement devices 406-410. In one implementation, the storage unit 426 also stores a data acquisition program 428 that allows a user to selectively start and stop the multiple detectors and measurement devices 406-410 in parallel and one at a time as well as customize the output format of the logs 412-416.

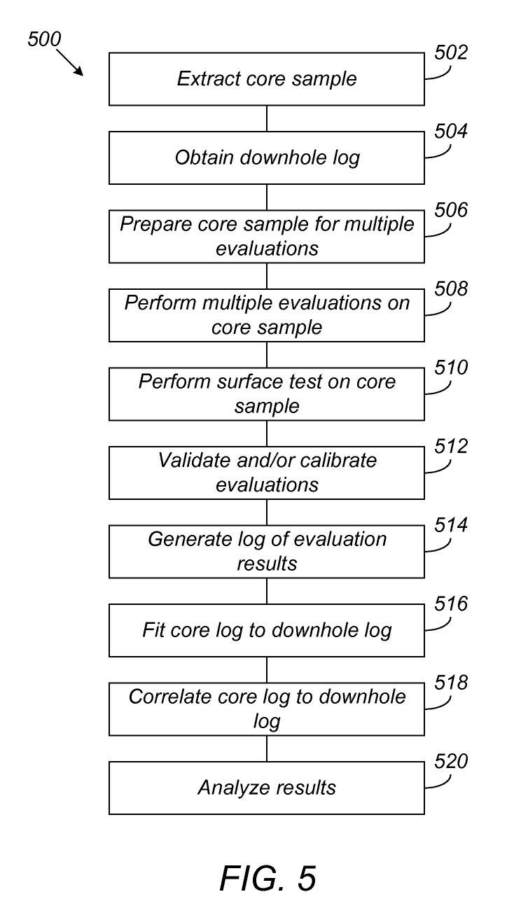

FIG. 5 illustrates in flowchart form an exemplary multi-evaluation core analysis method 500 for substantially simultaneously obtaining multiple types of core sample evaluations that may be used with the multi-evaluation core analysis apparatus 300 of FIG. 3 and/or the multi-evaluation core analysis system 400 of FIG. 4. It should be noted that, although a number of discrete steps are shown in FIG. 5, those having ordinary skill in the art will understand that two or more steps may be combined into a single step and that any individual step may be divided into several constituent steps as needed for a particular application. And although the steps have been shown in a particular sequence, those having ordinary skill in the art are certainly capable of rearranging the sequence as needed for a particular application, with some steps even performed in parallel instead of sequentially. Furthermore, one or more additional steps may be added to or one or more current steps may be removed from the core analysis method 500 by those having ordinary skill in the art as needed for a particular application.

As can be seen, the core analysis method 500 generally begins at step 502, where a core sample is extracted from a desired interval in the subterranean formation under investigation. At this time, a downhole log of the formation interval may also be obtained via step 504 (e.g., using a wireline tool) for later comparison to a log of the core sample. The core sample is then prepared (e.g., cleaned, placed on a conveyor belt, etc.) as needed at step 506 in a manner known to those having ordinary skill in the art. At step 508, multiple types of evaluations of the nature and character discussed herein with respect to FIG. 3 are performed on the core sample in a manner known to those having ordinary skill in the art. Preferably, the evaluations are performed in a single pass of the core sample, but it is certainly possible to perform the evaluations using multiple passes of the core sample as needed. Other surface tests, such as a hardness test or scratch test, may also be performed on the core sample as needed at this time via step 510.

Once at least one set of evaluations have been completed, the results thereof may be used to validate and/or calibrate the test setup at step 512. For example, the rate at which the core sample is conveyed through the isolation tunnel (see FIG. 3) may be calibrated at this time so as to provide an optimized rate for all the types of evaluations. In addition, the spacing of the various detectors and measurement devices as well as their distances from any gamma, neutron, or sonic sources and the like may also be optimized at this time. Validation may be performed by comparing the results of the evaluation using the multi-evaluation core analysis method 500 with results obtained using conventional techniques.

At least one log of the core sample evaluation results is generated at step 514 and fitted to the downhole log at step 516. The two logs are correlated at step 518 in a manner known to those having ordinary skill in the art, and the results analyzed at step 520.

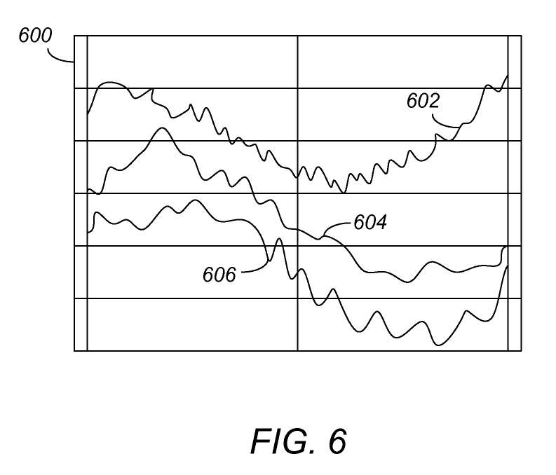

FIG. 6 illustrates an example of a multi-evaluation core log 600 having multiple types of evaluations that may be generated using the multi-evaluation core analysis apparatus 300 of FIG. 3, the multi-evaluation core analysis system 400 of FIG. 4, and/or the multi-evaluation core analysis system 500 of FIG. 5. As can be seen, the log 600 is similar to a standard core log commonly obtained from typical core sample evaluations insofar as the format of the log is concerned (e.g., vertical and horizontal axes, spacing of grid lines, etc.). However, unlike a standard core log, the multi-evaluation core log 600 contains measurements and readings from multiple types of evaluations. The measurements and readings, identified at 602, 604, and 606, may be taken substantially simultaneously with one another (as shown here), or they may be taken sequentially and subsequently superimposed on top of one another. These measurements and readings and measurements may include, for example, spectral gamma, total gamma, nuclear, electromagnetic, sonic, compensated density, compensated neutron, photoelectric absorption index, near-infrared, resistivity, elemental capture spectroscopy, X-ray diffraction, light absorption spectra, and Fourier transform infrared spectroscopy responses and the like. Such a multi-evaluation core log 600 can provide a much more robust and flexible way of evaluating core samples compared to existing techniques.

The foregoing description is provided for purposes of illustrating, explaining and describing certain aspects of the invention in particular detail. Those having ordinary skill in the art will understand that modifications and adaptations to the described methods, systems and other embodiments may be made without departing from the scope or spirit of the invention.

1. A multi-evaluation subterranean core sample analysis apparatus, comprising:
an isolation tunnel having an interior area substantially shielded from background radiation;
a conveyor belt configured to convey a core sample through the interior area of the isolation tunnel, the core sample being extracted from a subterranean formation; and
a multi-detector carriage assembly positioned adjacent to the conveyor belt and configured to house, a nuclear detector and one or more of the following: an electromagnetic detector, a sonic detector, a compensated density detector, a compensated neutron detector, and a photoelectric absorption cross-section index detector,
wherein each detector is configured to conduct a different type of evaluation on the core sample.

2. The apparatus of claim 1, further comprising support structures adapted to fixedly hold each detector.

3. The apparatus of claim 1, further comprising support structures adapted to securely mount one or more radiation sources for one or more of the detectors.

4. The apparatus of claim 1, further comprising a display for displaying measurements and readings from the detectors.

5. The apparatus of claim 1, wherein the conveyor belt is configured to convey the core sample at a predetermined speed, the predetermined speed being optimized for the different types of evaluations.

6. The apparatus of claim 1, wherein at least one of the detectors further comprise at least one lithium glass detector and at least one sodium iodide detector.

7. The apparatus of claim 6, wherein the at least one sodium iodide detector is oriented in a direction substantially perpendicular to the core sample.

8. A multi-evaluation subterranean core sample analysis system, comprising:
a nuclear detector and one or more of the following: an electromagnetic detector, a sonic detector, a compensated density detector, a compensated neutron detector, and a photoelectric absorption cross-section index detector, each detector designed to conduct a different type of evaluation on a core sample, the core sample being extracted from a subterranean formation;
a data acquisition unit connected to, each detector, the data acquisition unit configured to acquire readings from the each detector substantially in parallel; and
a display connected to the data acquisition unit, the display configured to display the readings acquired by the data acquisition unit.

9. The system according to claim 8, wherein the data acquisition unit is further configured to output the readings from each detector to a plurality of logs substantially in parallel.

10. The system according to claim 8, wherein the data acquisition unit is further configured to process the readings from each detector and to store the readings in a data storage unit.

11. The system according to claim 8, wherein the data acquisition unit is further configured to sequentially acquire the readings from a plurality of the detectors.

12. The system according to claim 8, wherein the readings from each detector include one or more of: digital readings, and analog readings.

13. The system according to claim 8, wherein at least one of the evaluations conducted on the core sample was previously conducted only in a wellbore.

14. The system according to claim 8, wherein at least one of the evaluations conducted on the core sample cannot be easily conducted in a wellbore.

15. The system according to claim 8, wherein at least one of the evaluations conducted on the core sample was previously conducted only in a laboratory environment.

16-20. (canceled)

21. The apparatus of claim 1, further comprising:
a nuclear detector, an electromagnetic detector, a sonic detector, a compensated density detector, a compensated neutron detector, and a photoelectric absorption cross-section index detector.

22. The system of claim 8, further comprising:
a nuclear detector, an electromagnetic detector, a sonic detector, a compensated density detector, a compensated neutron detector, and a photoelectric absorption cross-section index detector.
